(19) United States
(12) Patent Application Publication
(10) Pub. No.: US 2025/0222429 A1
(43) Pub. Date: Jul. 10, 2025

(54) CO2 Sequestration Glass Composition, Products Comprising the Same, and Method for Producing Carbon-Negative Glass

(71) Applicant: Minima Scientific, PBC, Golden, CO (US)

(72) Inventor: Brian Gorman, Golden, CO (US)

(21) Appl. No.: 19/016,908

(22) Filed: Jan. 10, 2025

Related U.S. Application Data
(60) Provisional application No. 63/619,428, filed on Jan. 10, 2024.

(51) Int. Cl. B01J 20/04; B01D 53/62; B01D 53/82; B01J 20/28; B01J 20/30; B01J 20/32; C02F 1/28; C02F 101/10; C03B 5/00; C03C 3/064; C03C 3/089; C03C 8/02; C03C 13/00; C04B 41/00; C04B 41/50; C04B 41/86

(52) U.S. Cl. CPC B01J 20/041; B01D 53/62; B01D 53/82; B01J 20/28023; B01J 20/28026; B01J 20/3078; B01J 20/3236; C02F 1/281; C03C 3/064; C03C 3/089; C03C 8/02; C03C 13/00; C04B 41/009; C04B 41/5022; C04B 41/86; B01D 2251/304; B01D 2251/402; B01D 2251/604; B01D 2257/504; B01D 2258/06; C02F 2101/10; C03B 5/00; C03C 2209/00; C03C 2213/00

(57) ABSTRACT

A method of preparing a carbon-negative glass along with products and uses of said carbon-negative glass. The method comprising: (a) selecting an oxide glass having a composition characterized as comprising: 0-60 mol % SiO₂; 0-60 mol % B₂O₃; 20-50 mol % MO, wherein M is one or more alkaline earth elements; 5-50 mol % R₂O, wherein R is one or more alkaline elements; 0-60 mol % P₂O₅; 0-3 mol % Al₂O₃; and 0-15 mol % Fe₂O₃; (b) selecting raw materials that comprise about 5 mol % or less of carbon at amounts suitable to form a batch that yields the oxide glass upon heating the batch to at least the melting temperature; (c) heating the batch to at least the melting temperature to produce molten oxide glass; and (d) decreasing the temperature of the molten oxide glass to produce solid oxide glass thereby forming the carbon-negative glass.

### CROSS-REFERENCE TO RELATED APPLICATIONS

This application claims the benefit of U.S. Provisional Application 63/619,428, filed on Jan. 10, 2024, which is incorporated herein by reference in its entirety.

### FIELD OF THE INVENTION

Glass formulations and products comprising such glass formulations that are “carbon negative” (i.e., the glass formulations a capable of reacting with and sequestering more CO₂ via weathering than the amount of CO₂ emitted in the production of the glass formulations).

### BACKGROUND OF INVENTION

Enhanced weathering (also known as carbon or sequestration) is a greenhouse gas mitigation strategy whereby CO₂ is removed from the atmosphere by binding reacting it with materials comprising alkaline earth elements such as calcium, barium, strontium, and/or magnesium. Enhanced weathering is being investigated in geochemical systems using mafic and ultramafic minerals.

Exposure of CO₂ to water (e.g., rain, streams, lakes, oceans, anthropogenic sources, etc.), forms carbonic acid (carbonated water), which reacts with mafic materials at the microscopic level. Solid, harmless carbonates such as magnesite, limestone, and dolomite are produced as a result of this reaction. This process offers a permanent solid conversion (sequestration) of gaseous CO₂ versus a temporary storage solution. The weathering process breaks down the silicate-containing materials as the reaction is destructive at the microscopic level.

A need exists for engineered materials and products that greatly increase the reaction rates and availability of these materials on a global scale.

### SUMMARY OF INVENTION

One embodiment of the present invention is directed to a method of preparing a carbon-negative glass, the method comprising:
(a) selecting an oxide glass having a composition characterized as comprising:
   SiO₂ at an amount in a range of 0 mol % to about 60 mol %;
   B₂O₃ at an amount in a range of 0 mol % to about 60 mol %;
   MO at an amount in a range of about 20 mol % to about 50 mol %, wherein M is one or more alkaline earth elements;
   R₂O at an amount in a range of about 5 mol % to about 50 mol %, wherein R is one or more alkaline elements;
   P₂O₅ at an amount in a range of 0 mol % to about 60 mol %;
   Al₂O₃ at an amount in a range of 0% to about 3 mol %; and
   Fe₂O₃ at an amount in a range of 0% to about 15 mol %;
(b) selecting raw materials that comprise about 5 mol % or less of carbon at amounts suitable to form a batch that yields the oxide glass upon heating the batch to at least the melting temperature;
(c) heating the batch to at least the melting temperature to produce molten oxide glass; and
(d) decreasing the temperature of the molten oxide glass to produce solid oxide glass thereby forming the carbon-negative glass.

One embodiment of the present invention is directed to a glass product consisting of an oxide glass having and a composition characterized as comprising:
SiO₂ at an amount in a range of 0 mol % to about 60 mol %;
B₂O₃ at an amount in a range of 0 mol % to about 60 mol %;
MO at an amount in a range of about 20 mol % to about 50 mol %, wherein M is one or more alkaline earth elements;
R₂O at an amount in a range of about 5 mol % to about 50 mol %, wherein R is one or more alkaline elements; and
P₂O₅ at an amount in a range of 0 mol % to about 60 mol %;
wherein the glass product has a configuration selected from the group consisting of fibers having a cross-sectional distance perpendicular to an axis of fiber formation that is no greater than about 100 μm, particles having a largest cross-sectional distance that is no greater than about 500 μm, frit, a tile, a brick, a block, and a paver.

One embodiment of the present invention is directed to a glass product consisting of the carbon-negative glass prepared according to the method set forth in the above embodiment, wherein the glass product has a configuration selected from the group consisting of fibers having a cross-sectional distance perpendicular to an axis of fiber formation that is no greater than about 100 μm, particles having a largest cross-sectional distance that is no greater than about 500 μm, a filter, frit, a tile, a brick, a block, and a paver.

One embodiment of the present invention is directed to a ceramic product comprising a ceramic substrate and a fired glaze on at least a portion of the ceramic substrate, wherein a constituent of the glaze is an oxide glass having a composition characterized as comprising:
SiO₂ at an amount in a range of 0 mol % to about 60 mol %;
B₂O₃ at an amount in a range of 0 mol % to about 60 mol %;
MO at an amount in a range of about 20 mol % to about 50 mol %, wherein M is one or more alkaline earth elements;
R₂O at an amount in a range of about 5 mol % to about 50 mol %, wherein R is one or more alkaline elements; and
P₂O₅ at an amount in a range of 0 mol % to about 60 mol %.

One embodiment of the present invention is directed to a ceramic product comprising a ceramic substrate and a fired glaze on at least a portion of the ceramic substrate, wherein a constituent of the glaze is the carbon-negative glass prepared according to the method set forth in the above embodiment, and wherein the ceramic product has a configuration selected from the group consisting of tile, brick, and sanitary ware.

One embodiment of the present invention is directed to a sacrificial ceramic CO₂ sequestration architectural product, wherein the sacrificial ceramic CO₂ sequestration architectural product comprises a sintered/heat-treated mixture having an open porosity (determined by ASTM C830) that is in a range from about 15 vol % to about 50 vol %, wherein the sintered/heat-treated mixture comprises:
an amount of a glass product in a range of about 20 wt % to about 50 wt % of the sintered/heat-treated mixture, wherein the glass product has a configuration selected from the group consisting of fibers having a cross-sectional distance perpendicular to an axis of fiber formation that is no greater than about 100 μm, particles having a largest cross-sectional distance that is no greater than about 500 μm, and a combination thereof, and wherein the glass product consists of an oxide glass having a composition characterized as comprising:
   SiO₂ at an amount in a range of 0 mol % to about 60 mol %;
   B₂O₃ at an amount in a range of 0 mol % to about 60 mol %;
   MO at an amount in a range of about 20 mol % to about 50 mol %, wherein M is one or more alkaline earth elements;
   R₂O at an amount in a range of about 5 mol % to about 50 mol %, wherein R is one or more alkaline elements; and
   P₂O₅ at an amount in a range of 0 mol % to about 60 mol %.

One embodiment of the present invention is directed to a process for making the sacrificial ceramic CO₂ sequestration architectural product that comprises a sintered/heat-treated mixture, the process comprising:
creating a mixture that comprises a glass product in a range of about 25 wt % to about 50 wt % of the mixture solids, wherein the glass product has a configuration selected from the group consisting of fibers having a cross-sectional distance perpendicular to an axis of fiber formation that is no greater than about 100 μm, particles having a largest cross-sectional distance that is no greater than about 200 μm, and a combination thereof, and wherein the glass product consists of an oxide glass having a composition characterized as comprising:
   SiO₂ at an amount in a range of 0 mol % to about 60 mol %;
   B₂O₃ at an amount in a range of 0 mol % to about 60 mol %;
   MO at an amount in a range of about 20 mol % to about 50 mol %, wherein M is one or more alkaline earth elements;
   R₂O at an amount in a range of about 5 mol % to about 50 mol %, wherein R is one or more alkaline elements; and
   P₂O₅ at an amount in a range of 0 mol % to about 60 mol %;
forming the mixture; and heating the formed mixture yield the sintered/heat-treated mixture,
wherein the sintered/heat-treated mixture has an open porosity (determined by ASTM C830) that is in a range from about 15 vol % to about 30 vol %.

One embodiment of the present invention is directed to a process for sequestering atmospheric CO₂, the process comprising dispersing onto or within land a glass product having a configuration selected from the group consisting of fibers having a cross-sectional distance perpendicular to an axis of fiber formation that is no greater than about 100 μm, particles having a largest cross-sectional distance that is no greater than about 500 μm, and a combination thereof, and wherein the glass product consists of an oxide glass having a composition characterized as comprising:
SiO₂ at an amount in a range of 0 mol % to about 60 mol %;
B₂O₃ at an amount in a range of 0 mol % to about 60 mol %;
MO at an amount in a range of about 20 mol % to about 50 mol %, wherein M is one or more alkaline earth elements;
R₂O at an amount in a range of about 5 mol % to about 50 mol %, wherein R is one or more alkaline elements; and
P₂O₅ at an amount in a range of 0 mol % to about 60 mol %;

which exposes the dispersed glass product to CO₂ captured in water to form carbonic acid, which reacts with the alkaline earth elements and the alkaline elements in the oxide glass to produce carbonates, thereby sequestering atmospheric CO₂.

### BRIEF DESCRIPTION OF THE DRAWINGS

FIG. 1 is a flowchart illustrating an embodiment of a process of carbon sequestering product preparation, formation, and usage.

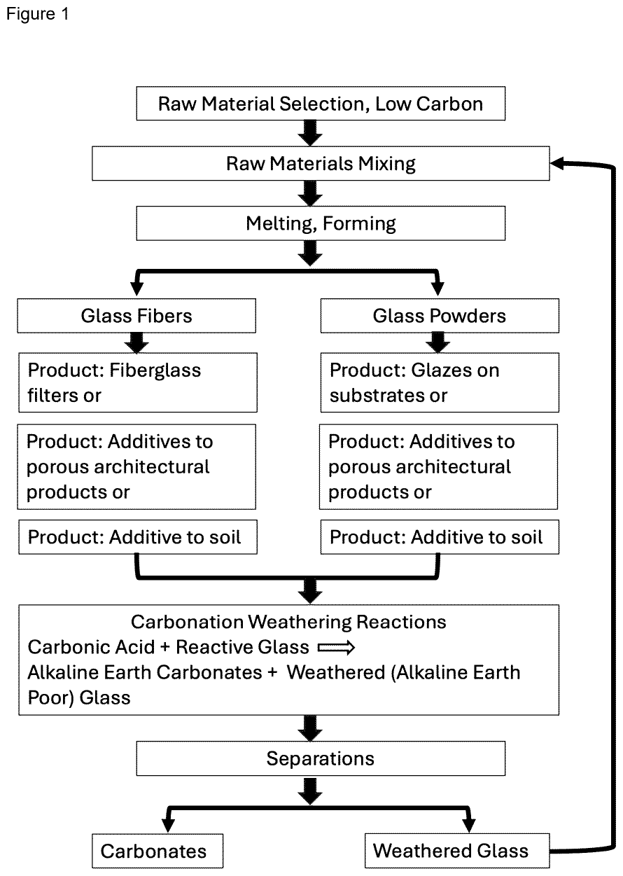

FIG. 2 is a photograph of a glass produced from a mixture comprising about 50 wt % talc and about 50 wt % borax melted in a silica crucible at about 1000° C., wherein the glass has a green color, and the white spots are carbonation reactions on the surface.

FIG. 3 is an scanning electron microscopy (SEM) micrograph of melted and ground 50% talc+50% borax glass before reacting with aqueous carbonic acid.

FIG. 4 is an scanning electron microscopy (SEM) micrograph of melted and ground 50% talc+50% borax glass after reacting with aqueous carbonic acid for 2 weeks, wherein the white areas are Mg(CO₃)₂ precipitates.

FIG. 5 is a Raman spectrum of the 50% talc+50% borax glass, which shows a mixture of SiO₄ (Q4) and SiO(Q1) silicate structures along with B3 borate structure.

FIG. 6 is a plot of XRD data of the 50% talc+50% borax glass before (gray) and after (black) reacting with aqueous carbonic acid for 2 weeks. A change in the glass structure to higher 2-theta values indicates shorter average bond lengths and more Q4 (SiO₄) structure.

FIG. 7 is an SEM micrograph of a 60% talc+40% borax glass after holding at the melting temperature at about 1275° C. for about 36 hours, wherein the darker areas within the glass matrix are precipitated carbonates, which demonstrates that the glass formulations may even be used to react with CO₂ during the melting process.

### DETAILED DESCRIPTION OF INVENTION

### I. Method of Preparing a Carbon-Negative Glass

One embodiment of the present invention is directed to a method preparing a carbon-negative glass, wherein “carbon negative” means the glass is capable of reacting with and sequestering more CO₂ via weathering than the amount of CO₂ emitted in the production of the glass. The glass has a composition characterized as comprising:
SiO₂ at an amount in a range of 0 mol % to about 60 mol %;
B₂O₃ at an amount in a range of 0 mol % to about 60 mol %;
MO at an amount in a range of about 20 mol % to about 50 mol %, wherein M is one or more alkaline earth elements;
R₂O at an amount in a range of about 5 mol % to about 50 mol %, wherein R is one or more alkaline elements;
P₂O₅ at an amount in a range of 0 mol % to about 60 mol %;
Al₂O₃ at an amount in a range of 0% to about 3 mol %; and
Fe₂O₃ at an amount in a range of 0% to about 15 mol %.

In one embodiment, the method may comprise selecting an oxide glass having a melting temperature not greater than about 1,200° C.

In one embodiment, the oxide glass composition is characterized as comprising:
SiO₂ at an amount in a range of about 10 mol % to about 50 mol %;
B₂O₃ at an amount in a range of about 10 mol % to about 50 mol %;
MO at an amount in a range of about 25 mol % to about 45 mol %, wherein M is one or more alkaline earth elements;
R₂O at an amount in a range of about 10 mol % to about 40 mol %, wherein R is one or more alkaline elements; and
P₂O₅ at an amount in a range of about 10 mol % to about 50 mol %.

In one embodiment, the oxide glass composition is characterized as comprising:
SiO₂ at an amount in a range of about 20 mol % to about 40 mol %;
B₂O₃ at an amount in a range of about 20 mol % to about 40 mol %;
MO at an amount in a range of about 30 mol % to about 40 mol %, wherein M is one or more alkaline earth elements;
R₂O at an amount in a range of about 15 mol % to about 30 mol %, wherein R is one or more alkaline elements; and
P₂O₅ at an amount in a range of about 20% to about 40 mol %.

In certain embodiments, M is selected from the group consisting of Ca, Mg, Ba, and combinations thereof.

In one embodiment, R is selected from the group consisting of Na, K, Li, and combinations thereof.

Additionally, the method comprises selecting low-carbon raw materials for the glass. For example, low-carbon raw materials comprise about 5 mol % or less of carbon at amounts suitable to form a batch that yields the oxide glass upon heating the batch to at least the melting temperature. Examples of such low-carbon raw materials include borax (Na₂B₄O₇•10H₂O), sodium silicate (Na₂SiO₃), sodium phosphate (Na₃PO₄), forsterite (Mg₂SiO₄), talc (Mg₃Si₄O₁₀(OH)₂), serpentite (Mg₆Si₄O₁₀(OH)₈), apatite, (Ca₅(PO₄)), diopside (MgCaSi₂O₆), boracite (Mg₃B₇O₁₃Cl), wollastonite (CaSiO₃), ultramafic basalts, fly ash, boiler ask, cement, soda lime glass, aqueous solutions, and combinations thereof.

The method further comprises heating the batch to at least the melting temperature to produce molten oxide glass and decreasing the temperature of the molten oxide glass to produce solid oxide glass thereby forming the carbon-negative glass. The batch may be melted using essentially any method of heating (e.g., gas or electricity). That said, the degree to which the glass may be carbon-negative may be increased by using renewable energy sources (e.g., electricity from wind, solar, geothermal, etc.).

### A. Talc and Borax Embodiment

In one embodiment, the oxide glass composition is characterized as comprising:
SiO₂ at an amount in a range of about 30 mol % to about 50 mol %;
B₂O₃ at an amount in a range of about 15 mol % to about 30 mol %;
CaO at an amount in a range of 0 mol % to about 10 mol %;
MgO at an amount in a range of about 25 mol % to about 35 mol %;
Na₂O at an amount in a range of about 5 mol % to about 15 mol %; and
K₂O at an amount in a range of 0 mol % to about 5 mol %.

Such a selected oxide glass composition may, for example, be produced using talc and borax as the raw materials.

### B. Slag and Sodium Silicate Embodiment

In one embodiment, the selected oxide glass composition is characterized as comprising:
SiO₂ at an amount in a range of about 30 mol % to about 45 mol %;
B₂O₃ at an amount in a range of 0 mol % to about 5 mol %;
CaO at an amount in a range of about 25 mol % to about 35 mol %;
MgO at an amount in a range of 0 mol % to about 5 mol %;
Na₂O at an amount in a range of about 5 mol % to about 15 mol %; and
K₂O at an amount in a range of 0 mol % to about 5 mol %.

Such a selected oxide composition may, for example, be produced using slag and sodium silicate as the raw materials.

### C. Ash and Borax Embodiment

In one embodiment, the selected oxide glass composition is characterized as comprising:
SiO₂ at an amount in a range of about 10 mol % to about 20 mol %;
B₂O₃ at an amount in a range of about 25 mol % to about 40 mol %;
CaO at an amount in a range of about 25 mol % to about 40 mol %;
MgO at an amount in a range of about 1 mol % to about 10 mol %; and
Na₂O at an amount in a range of about 10 mol % to about 20 mol %.

Such a selected oxide composition may, for example, be produced using ash and borax as the raw materials.

### II. Glass Products

The method of preparing a carbon-negative glass may further comprise forming the molten oxide glass so that the carbon-negative glass has a configuration selected from the group consisting of one or more fibers, one or more particles, a filter, frit, a tile, a block, a brick, and a paver.

In fact, one embodiment of the present invention is directed to a glass product consisting of an oxide glass, which need not be a carbon-negative glass. The oxide glass does, however, have a composition characterized as comprising:
SiO₂ at an amount in a range of 0 mol % to about 60 mol %;
B₂O₃ at an amount in a range of 0 mol % to about 60 mol %;
MO at an amount in a range of about 20 mol % to about 50 mol %, wherein M is one or more alkaline earth elements;
R₂O at an amount in a range of about 5 mol % to about 50 mol %, wherein R is one or more alkaline elements; and
P₂O₅ at an amount in a range of 0 mol % to about 60 mol %;

Further, the glass product has a configuration selected from the group consisting of fibers having a cross-sectional distance perpendicular to an axis of fiber formation that is no greater than about 100 μm, particles having a largest cross-sectional distance that is no greater than about 500 μm, frit, a tile, a brick, a block, and a paver.

### A. Fiber Configuration Embodiments

In one embodiment, the selected configuration is one or more fibers, wherein the formed fiber(s) of the carbon-negative glass have a cross-sectional distance perpendicular to an axis of fiber formation that is no greater than about 100 μm. In another such fiber configuration embodiment, the cross-sectional distance of the fiber(s) of the carbon-negative glass is no greater than about 10 μm. In yet another fiber configuration embodiment, the cross-sectional distance of the fiber(s) of the carbon-negative glass is in a range of about 1 μm to about 100 μm.

### B. Particle Configuration Embodiments

In one embodiment, the selected configuration is one or more particles, wherein the formed particle(s) of the carbon-negative glass have a largest cross-sectional distance that is no greater than about 500 μm. In another such particle configuration embodiment, the largest cross-sectional distance of the particle(s) of the carbon-negative glass is no greater than about 10 μm. In yet another particle configuration embodiment, the largest cross-sectional distance of the particle(s) of the carbon-negative glass is in a range of about 1 μm to about 200 μm.

### III. Process for Sequestering Atmospheric CO₂ Using the Glass Products.

In one embodiment, the aforementioned fiber and particle configurations of the oxide glass (or carbon-negative glass) are used to sequester atmospheric carbon dioxide. In particular such an embodiment is a process for sequestering atmospheric CO₂, that comprises dispersing onto or within land a glass product having a configuration selected from the group consisting of fibers having a cross-sectional distance perpendicular to an axis of fiber formation that is no greater than about 100 μm, particles having a largest cross-sectional distance that is no greater than about 100 μm, and a combination thereof, and wherein the glass product consists of an oxide glass having a composition characterized as comprising:
SiO₂ at an amount in a range of 0 mol % to about 60 mol %;
B₂O₃ at an amount in a range of 0 mol % to about 60 mol %;
MO at an amount in a range of about 20 mol % to about 50 mol %, wherein M is one or more alkaline earth elements;
R₂O at an amount in a range of about 5 mol % to about 50 mol %, wherein R is one or more alkaline elements; and
P₂O₅ at an amount in a range of 0 mol % to about 60 mol %;

which exposes the dispersed glass product to CO₂ dissolved in water to form carbonic acid, which reacts with the alkaline earth elements and the alkaline elements in the oxide glass to produce carbonates, thereby sequestering atmospheric CO₂.

In one such embodiment the land is adjacent a body of water. In another such embodiment the land is farmland. Although the rate of dispersal may be essentially any amount that is acceptable, for example, in terms of visual appearance or texture, it is believed that such glass products may be dispersed at a rate in a range of about 10 to about 50 tonnes per hectare per year. Beerling et al., Potential for large-scale CO₂ removal via enhanced rock weathering with croplands, Nature 583, 242-248 (2020).

Upon the glass being weathered (i.e., the formed carbonates separate from the remaining glass), the remaining glass composition may be separated and reused as cullet for new sequestering glass products.

### IV. Glazed Ceramic Products

In one embodiment, the invention is directed to ceramic product comprising a ceramic substrate and a fired glaze on at least a portion of the ceramic substrate, wherein a constituent of the glaze is an oxide glass having a composition characterized as comprising:
SiO₂ at an amount in a range of 0 mol % to about 60 mol %;
B₂O₃ at an amount in a range of 0 mol % to about 60 mol %;
MO at an amount in a range of about 20 mol % to about 50 mol %, wherein M is one or more alkaline earth elements;
R₂O at an amount in a range of about 5 mol % to about 50 mol %, wherein R is one or more alkaline elements; and
P₂O₅ at an amount in a range of 0 mol % to about 60 mol %.

Exemplary configurations of such a ceramic product include tiles, bricks, and sanitary ware.

In one such ceramic product embodiment, the oxide glass is a carbon-negative glass such as that produced according to the above described method(s) of preparing a carbon-negative glass.

### V. CO₂-Sequestering Architectural Products

In another embodiment, the present invention is directed to CO₂-sequestering architectural products (e.g., panels, tiles, bricks/pavers, etc.) that comprise a sintered/heat-treated mixture having an open porosity (determined by ASTM C830) that is in a range from about 15 vol % to about 50 vol %, wherein the sintered/heat-treated mixture comprises a glass product consisting of an oxide glass as described above, which may be a carbon-negative glass. In another embodiment, the CO₂-sequestering architectural product consists of the sintered/heat-treated mixture. Such architectural products may be placed on or used to form a horizontal surface (e.g., a floor or walkway) or a vertical surface such as a wall cladding. Such products may also be used as roofing materials (flat or sloped). In addition to the glass product, the CO₂-sequestering architectural products may comprise other materials rich in reactive minerals such as olivine (described in more detail below).

### A. General Description of a Process for Making a Ceramic CO₂ Sequestration Architectural Product

In general, the process involves creating a mixture of suitable ingredients at suitable relative amounts for the particular end use or application, forming the mixture in the desired type of product such as a tile, brick, paver, etc. (e.g., via extrusion or another appropriate technique), and heating the formed mixture to yield a sintered or heat-treated mixture that is a ceramic capable of CO₂ sequestration. The mixture of ingredients typically comprises a binder that is lost in drying and/or heat-treating the formed mixture. Such binder include water and/or conventional organic binder compounds used to aid in mixing, forming, and to impart adequate “green” strength to the formed mixture.

Unlike conventional architectural or building products which are specifically designed for longevity, CO₂ sequestration products of the present invention are designed to chemically react with their environments. The rate of deterioration depends on a variety of factors, including composition, particle size, surface area, porosity, etc.

Further, in certain embodiments, the CO₂ sequestration architectural products of the present invention may be formulated and produced to optimize environmental degradation at the expense of structural properties. In fact, the CO₂ sequestration architectural products of the present invention may be designed to be non-structural, nondurable, and weather-away as fast as possible. In such embodiments, mechanical strength and low water absorption need only be sufficient to maintain tile integrity during the life of product. Such CO₂ sequestration architectural products will typically be formulated to have relatively high concentrations of reactive solids to maximize the CO₂ reaction activity at the expense of longevity.

### B. Ingredients of the Ceramic CO₂ Sequestration Architectural Products

The purpose of this invention is to replace or substitute some ingredients in architectural products (e.g., panels, tiles, bricks/pavers, etc.) that provide no direct environmental benefit related to CO₂. The ceramic CO₂ sequestration architectural products of the present invention are believed, over their useful life, to have a “net negative” CO₂ footprint even factoring in the CO₂ produced as a byproduct of the manufacturing process, transportation, and installation.

### 1. Weathering Glass Product

Of particular relevance to the present invention, glass product of the present invention may be included in the sintered/heat-treated mixture that is included in the sacrificial ceramic CO₂ sequestration architectural product. As set forth above, the glass product consists of oxide glass having a composition characterized as comprising: SiO₂ at an amount in a range of 0 mol % to about 60 mol %; B₂O₃ at an amount in a range of 0 mol % to about 60 mol %; MO at an amount in a range of about 20 mol % to about 50 mol %, wherein M is one or more alkaline earth elements; R₂O at an amount in a range of about 5 mol % to about 50 mol %, wherein R is one or more alkaline elements; and P₂O₅ at an amount in a range of 0 mol % to about 60 mol %. This is likely to be considered advantageous because, in addition to being capable of weathering and also a carbon-negative glass, such glass compositions may function as a bridge between particulate in the mixture.

In certain embodiments, the oxide glass has a melting temperature that is not less than about 1,100° C. This is because it is often beneficial for the melting temperature of the oxide glass to not be significantly lower than the sintering/heat treatment temperature(s) needed for densification and microstructure development of the sintered/heat-treated mixture. Otherwise, depending upon the amount of such glass present in the mixture, if the sintering temperature is about the melting temperature of the glass or greater, the architecture product may deform during the sintering. Thus, in such embodiments, the oxide glass may, for example, have a melting temperature that is in a range of about 1,100° C. to about 1,200° C. Alternatively, the relative amount of the glass included in the mixture may be decreased to a point at which the deformation, if any, that may occur at the sintering temperature is acceptable.

In one embodiment, the glass product has a configuration selected from the group consisting of fibers having a cross-sectional distance perpendicular to an axis of fiber formation that is no greater than about 100 μm, particles having a largest cross-sectional distance that is no greater than about 200 μm, and a combination thereof. In such embodiments, the amount of the carbon sequestration glass product may be in a range of about 20 wt % to about 50 wt % of the mixture.

In another such embodiment, the carbon sequestration glass product is at amount that is in a range of about 30 wt % to about 40 wt % of the mixture.

### 2. Bridging Materials

The mixture may further comprise particles of one or more bridging materials selected from the group consisting of one or more clays, one or more feldspars, quartz, one or more soda lime glasses, one or more other glasses, and combinations thereof.

As described in more detail above, the glass of the present invention may function as a bridging material and as a weathering material. Generally, however, bridging materials such as cement, clays, feldspars, and quartz would not be considered weathering materials, they would be considered weather resistant.

In one embodiment, the relative total amount of the bridging materials (weathering and weather-resistant) is in a range from about 20 wt % to about 80 wt % of the mixture for forming a desirable sacrificial ceramic CO₂ sequestration architectural product. In another embodiment, the one or more bridging materials are at a total relative amount that is in a range from about 50 wt % to about 70 wt % of the mixture solids.

In one embodiment, the sintered/heat-treated mixture of the sacrificial ceramic CO₂ sequestration architectural product further comprises one or more non-reactive/weather-resistant materials at an amount in a range from about 20 wt % to about 80 wt % of the mixture, wherein the one or more weather-resistant materials selected from the group consisting of cement, one or more clays, one or more feldspars, quartz, and combinations thereof.

In such an embodiment: the cement, if present, is at a total relative amount in a range of about 25 wt % to about 75% of the mixture; the one or more clays, if present, are at total relative amount in a range of about 25 wt % to about 75 wt % of the mixture; the one or more feldspars, if present, are at total a relative amount in a range of about 10 wt % to about 40 wt % of the mixture; and the quartz, if present, is at a relative amount in a range of about 10 wt % to about 40 wt % of the mixture.

In another such embodiment: the cement, if present, is at a total relative amount in a range of about 40 wt % to about 60% of the mixture; the one or more clays, if present, are at total relative amount in a range of about 40 wt % to about 60 wt % of the mixture; the one or more feldspars, if present, are at total a relative amount in a range of about 20 wt % to about 30 wt % of the mixture; and the quartz, if present, is at a relative amount in a range of about 20 wt % to about 30 wt % of the mixture.

In one embodiment, the one or more bridging materials is a combination of one or more clays and one or more feldspars. In such an embodiment, the combination of one or more clays and one or more feldspars has a relative amount of the one or more clays that is in a range from about 50 wt % to about 70 wt % of the combination and a relative amount of the one or more feldspars that is in a range from about 30 wt % to about 50 wt % of the combination.

### 3. Body Colorants.

Trace minerals may be added to the mixture prior to firing to achieve a desired color-body throughout the thickness of the panel.

### C. Ceramic Tiles

Conventional ceramic tiles and panels are made of various raw materials such as clays, quartz, feldspar, and other trace minerals. A typical proportional mixture of these raw materials is: 25-75 wt % clays, 10-40 wt % feldspar and 10-40 wt % quartz. Another typical proportional mixture of these raw materials is: 40-60 wt % clays, 20-30 wt % feldspar, and 20-30 wt % quartz. Another formulation, in particular for porcelains, is about 50 wt % kaolin, about 25 wt % feldspar, and about 25 wt % quartz. Such tiles and panels are typically fired at temperatures from 1000 to 1500° C., with porcelains typically fired at higher temperatures and made with high quality ingredients.

The compositions of the present invention may also be used to produce bricks and pavers. However, bricks and pavers tend to be made using ingredients of lesser quality and cost compared to porcelain tiles.

### D. Surface Texture of the Sintered Architectural Product.

The ceramic tiles may have a surface that is smooth or have little surface texture, but the surface need not be smooth. In certain embodiments, the surface is rough as possible in order to increase surface area and, therefore, offer increased reaction area.

Regular or irregular geometric patterns, random or repeated textures consisting of embossed or debased areas help increase surface area. Textures or patterns pressed into the green panels before firing may extend to the top surface, side edges and bottom surface to encourage water flow to all areas of the panel. This increased surface texture increases the CO₂ removal reaction by exposing more glass to CO₂.

Certain embodiments of the CO₂ sequestration products have heavily textured surfaces to increase the area available for reaction with rainwater and provide a greater reduction of atmospheric CO₂. In one such embodiment, the forming of the mixture comprises configuring the formed mixture so that the sintered/heat-treated mixture has at least one major surface configured to have an effective surface area that is in a range from 20% to about 100% greater than a nominal macroscale area of said at least one major surface. In another such embodiment, the forming of the mixture comprises configuring the formed mixture so that the sintered/heat-treated mixture has at least one major surface configured to have an effective surface area that is in a range from 30% to about 70% greater than a nominal macroscale area of said at least one major surface.

In addition to enhancing the surface area, the forming of the mixture comprises configuring the formed mixture so that the sintered/heat-treated mixture is configured for installation with ceramic panel fasteners, screws, or nails.

### E. Temperature

The sintering/heat treatment should be conducted at temperature(s) sufficiently high for densification and microstructure development of the sintered/heat-treated mixture but not so high as to degrade the weather materials' susceptibility to atmospheric carbon mineralization. But the process of producing a sacrificial ceramic CO₂ sequestration architectural product from a mixture comprising weathering glasses should not be conducted at temperatures capable of devitrifying a significant portion of the weathering glass (e.g., a temperature in excess of the oxide glass crystallization temperature) into phases that are not susceptible to atmospheric carbon mineralization or weathering such as quartz. Further, the temperature should not be so high as to melt the oxide glass component of the mixture. In one embodiment, the mixture is heated to temperature(s) in a range from about 400° C. to about 800° C. for a duration in a range from about 1 minute to about 240 minutes. In such an embodiment, the oxide glass also functions to bind or bridge the crystalline reactive solid phases formed from the crystalline weathering materials during the sintering/heat-treatment (see below).

Alternatively, for embodiments in which non-reactive solid phases formed from the bridging materials such as clays and feldspars during the sintering/heat-treatment (see below) make up a significant portion of the mixture (e.g., at least about 50 wt % of the mixture solids), the sintering/heat-treatment temperature is typically increased to be in a range from about 900° C. to about 1,000° C. (or possibly as high as about 1,100° C. if the melting temperature of the oxide glass is greater such as about 1,200° C.) and the duration is in a range from about 4 hours to about 48 hours.

### F. The Sintered/Heat-Treated Mixture

Upon being subjected to the heat treatment, the sacrificial ceramic CO₂ sequestration architecture product comprises a sintered/heat-treated mixture that comprises an amount of a glass product in a range of about 20 wt % to about 50 wt % of the sintered/heat-treated mixture, wherein the glass product has a configuration selected from the group consisting of fibers having a cross-sectional distance perpendicular to an axis of fiber formation that is no greater than about 100 μm, particles having a largest cross-sectional distance that is no greater than about 500 μm, and a combination thereof, and wherein the glass product has a composition characterized as comprising: SiO₂ at an amount in a range of 0 mol % to about 60 mol %; B₂O₃ at an amount in a range of 0 mol % to about 60 mol %; MO at an amount in a range of about 20 mol % to about 50 mol %, wherein M is one or more alkaline earth elements; R₂O at an amount in a range of about 5 mol % to about 50 mol %, wherein R is one or more alkaline elements; and P₂O₅ at an amount in a range of 0 mol % to about 60 mol %.

Additionally, the sacrificial ceramic CO₂ sequestration architectural product comprising the sintered/heat-treated mixture has an open porosity (determined by ASTM C830) that is in a range from about 15 vol % to about 50 vol %. The porosity allows for interaction between air and/or water containing CO₂ and reactive solids, including the aforementioned glass product. Although such porosity is considered desirable for CO₂ sequestration, it is also desirable to select a porosity that does not prevent the product from being suitable for its intended use.

In one embodiment, the glass product is at amount in a range of about 30 wt % to about 40 wt % of the sintered/heat-treated mixture of the sacrificial ceramic CO₂ sequestration architectural product.

In one embodiment, the oxide glass of the sintered/heat-treated mixture is a carbon-negative glass.

In one embodiment, the sacrificial ceramic CO₂ sequestration architectural product consists of the sintered/heat-treated mixture.

### 1. Non-Reactive Solid Phases

The sintered/heat-treated mixture of a sacrificial ceramic CO₂ sequestration architectural product may also comprise one or more non-reactive solid phases that may be characterized as one or more bridging phases that bridge the one or more crystalline reactive solid phases. These non-reactive solid phases generally result from heat treatment of the above-described weather-resistant/bridging materials. As such, in one embodiment, the one or more non-reactive solid phases comprise one or more bridging materials selected from the group consisting of one or more clays, one or more feldspars, quartz, one or more generally non-reactive glasses such as conventional soda lime glasses and other glasses such as fused silica or quartz glass, and borosilicate glass.

In one embodiment, the relative total amount of the non-reactive solid phases is in a range from about 20 wt % to about 80 wt % of the sintered/heat-treated mixture of a sacrificial ceramic CO₂ sequestration architectural product. In another embodiment, the one or more non-reactive solid phases is in a range from about 50 wt % to about 70 wt % of the sintered/heat-treated mixture of a sacrificial ceramic CO₂ sequestration architectural product.

In one embodiment, the sintered/heat-treated mixture of the sacrificial ceramic CO₂ sequestration architectural product further comprises one or more non-reactive solid phases comprising bridging materials at an amount in a range from about 20 wt % to about 80 wt % (or about 50 wt % to about 70 wt %) of the mixture, wherein the one or more weather-resistant crystalline bridging materials selected from the group consisting of cement, one or more clays, one or more feldspars, quartz, and combinations thereof.

In such an embodiment: the cement, if present, is at a total relative amount in a range of about 25 wt % to about 75% of the mixture; the one or more clays, if present, are at total relative amount in a range of about 25 wt % to about 75 wt % of the mixture; the one or more feldspars, if present, are at total a relative amount in a range of about 10 wt % to about 40 wt % of the mixture; and the quartz, if present, is at a relative amount in a range of about 10 wt % to about 40 wt % of the mixture.

In another such embodiment: the cement, if present, is at a total relative amount in a range of about 40 wt % to about 60 wt % of the mixture; the one or more clays, if present, are at total relative amount in a range of about 40 wt % to about 60 wt % of the mixture; the one or more feldspars, if present, are at total a relative amount in a range of about 20 wt % to about 30 wt % of the mixture; and the quartz, if present, is at a relative amount in a range of about 20 wt % to about 30 wt % of the mixture.

In one embodiment, the one or more bridging materials is a combination of one or more clays and one or more feldspars. In such an embodiment, the combination of one or more clays and one or more feldspars has a relative amount of the one or more clays that is in a range from about 50 wt % to about 70 wt % of the combination and a relative amount of the one or more feldspars that is in a range from about 30 wt % to about 50 wt % of the combination.

### G. Surface Glazes

The products of the present invention may have a glazed surface made of a typical ceramic color engobe, primer, and/or surface coat applied prior to firing on one side of the panel to impart a color. This produces a panel that may be installed so the colored surface is visible to achieve a particular color of floor, wall, or roof, yet still remove CO₂ by rainwater flowing on the other sides or surfaces of the panel.

In one embodiment, the glaze on a least a portion of at least one major surface of the sintered/heat-treated mixture comprises a carbon-sequestering/weather oxide glass (optionally a carbon-negative glass) of the present invention. Such an oxide glass may be a second oxide glass of a different composition to the oxide glass included in the body of the architectural product.

### H. Securing and Sealing the CO₂ Sequestration Architectural Product.

Conventional ceramic tiles are designed to be installed with mortar, adhesive, or other mastic on the bottom of the tile to hold it in place.

Additionally, to reduce water infiltrating under the surface of convention tiles and causing the system to fail, a waterproof grout is typically used in and along the joint between adjoining tiles.

In certain embodiment, tiles and panel of the present invention may be installed without mortar on the mounting side or grout between panels to increase water flow all over and under the panel. For example, such panels may be large patio paver-sized and installed on a relatively flat surface and secured with gravity. Alternatively, such panels may be hung on a wall or secured on a roof using nails, screws, or other fasteners.

CO₂ sequestration panels may be applied over a waterproofing underlayment. The purpose of the underlayment is to protect the underlying surface from rainwater which is directed to the bottom surface of the panel by textures on the top and side edges of the panel.

Certain embodiment of CO₂ sequestration panels may lack the structural integrity of a typical ceramic building product. Hook-type hangers at the top, side and bottom edges may be employed to hold such panels in place to enable easy installation and replacement as panels wear-out (see, e.g., U.S. Pat. No. 9,926,704, which is incorporated by reference herein in its entirety).

### EXAMPLES

### Example 1-50/50 Mix of Talc and Borax

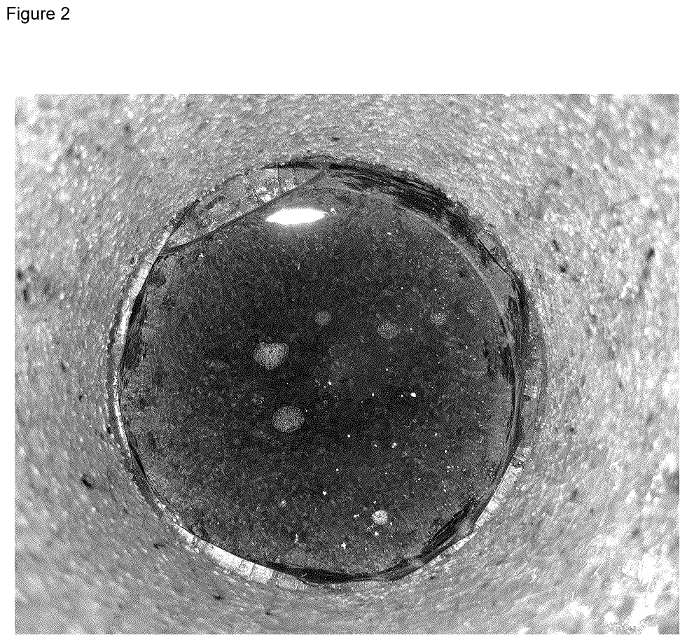

Talc (Mg₃Si₄O₁₀(OH)₂) and borax (Na₂B₄O₁₅(OH)₂) were mixed in equimolar concentrations and melted at about 1000° C. FIG. 2 is a photograph of the glass produced from the mixture and the photograph shows that the glass has a green color with spots on the surface. The white spots are carbonation reactions on the surface from the atmosphere. The glass was also spun into glass fibers<10 μm in diameter.

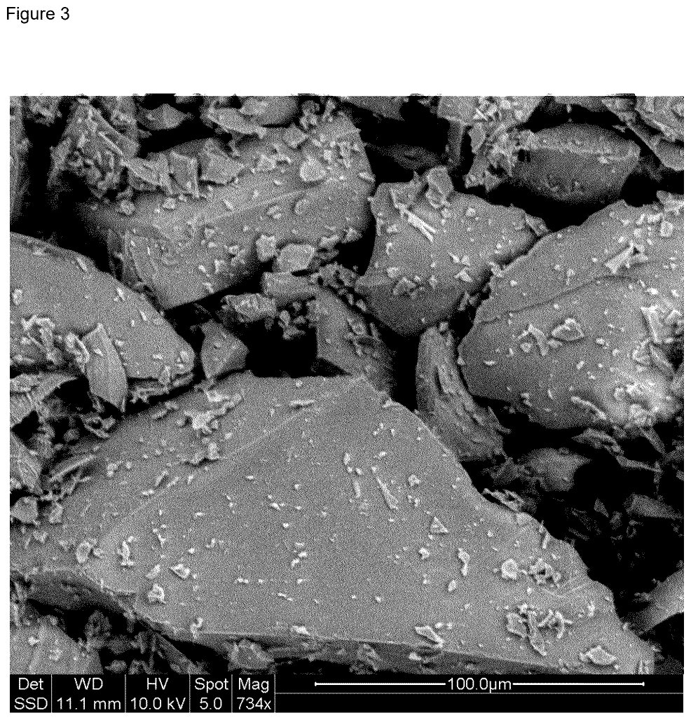

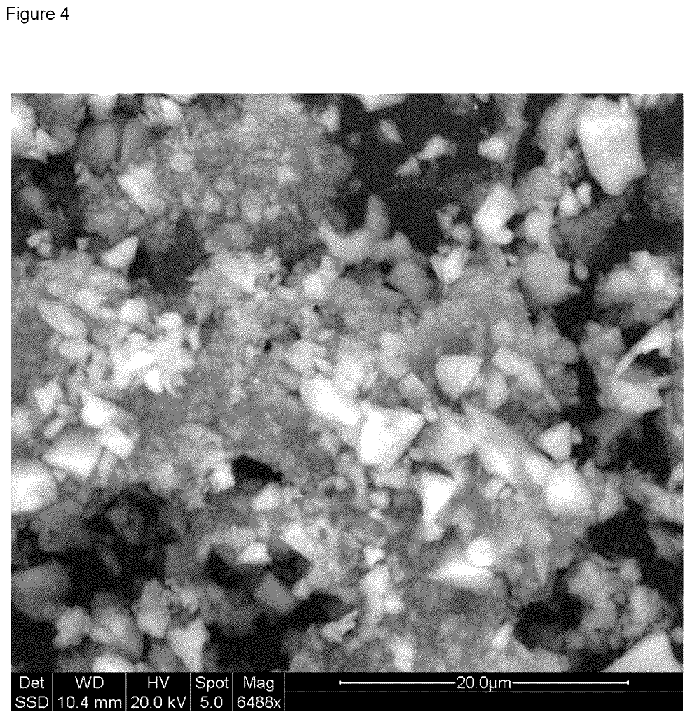

The glass composition was exposed to water in air for two weeks to simulate weathering. FIG. 3 is an SEM micrograph of the glass sample before it was reacted with the water. FIG. 4 is an SEM micrograph of the glass after reacting with aqueous carbonic acid for 2 weeks, wherein the white areas are Mg(CO₃)₂ precipitates.

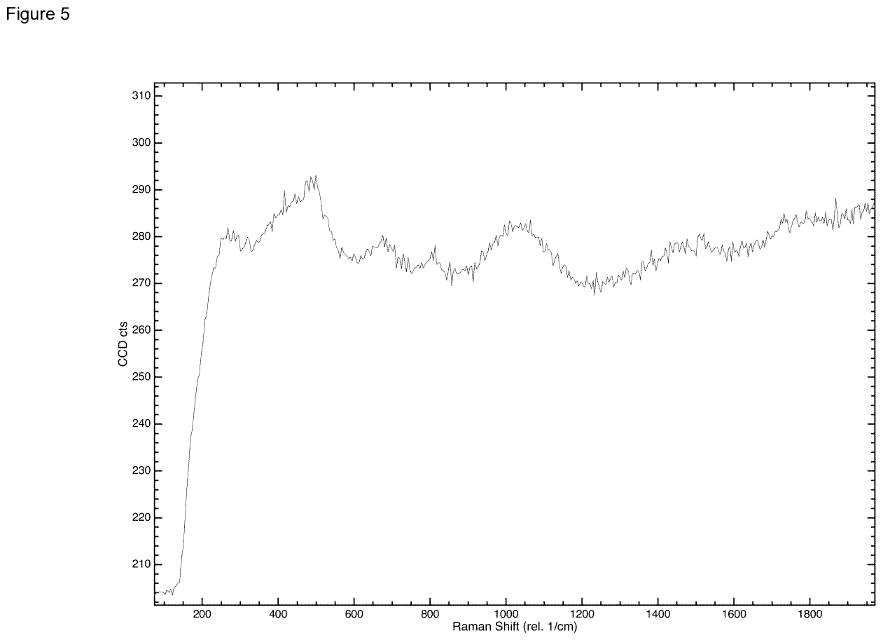

FIG. 5 is a Raman spectrum of the glass, which shows a mixture of SiO₄ (Q4) and SiO(Q1) silicate structures along with B3 borate structure. SiO₂ and B₂O₃ are glass network formers whereas Mg is an intermediate modifier and Na is a network modifier. Increasing Na concentrations reduces the melting temperature of the glass and also increases reactivity of the glass to allow Na and Mg to react with carbonic acid. B is a network former but is also highly soluble in water, again freeing more alkaline earth cations for carbonation reactions. Mg and Na are thus available for reactions with carbonic acid to form carbonates. The Mg(CO₃)₂ reacted after less than 2 weeks in water meaning the reaction rate is 2-3 orders of magnitude higher than olivine.

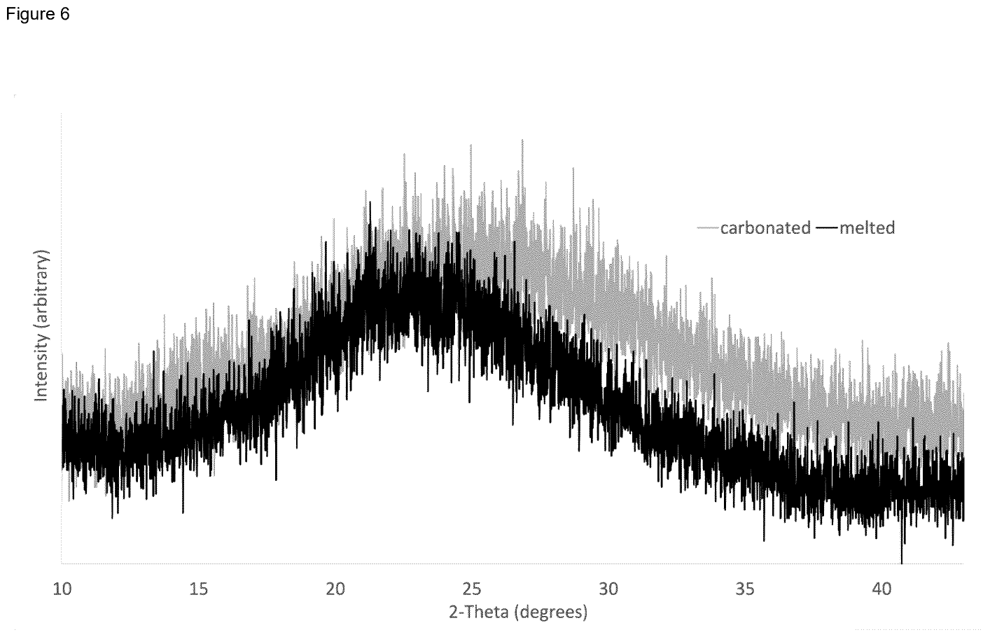

FIG. 6 contains XRD data of the 50% talc+50% borax glass. The gray curve represents the glass before being subjected to the carbonic acid and the black is of the glass after the carbonic acid. The change in the glass structure to higher 2-theta values indicates shorter average bond lengths and more Q4 (SiO₄) structure.

### Example 2-60%/40% Mix of Talc/Borax

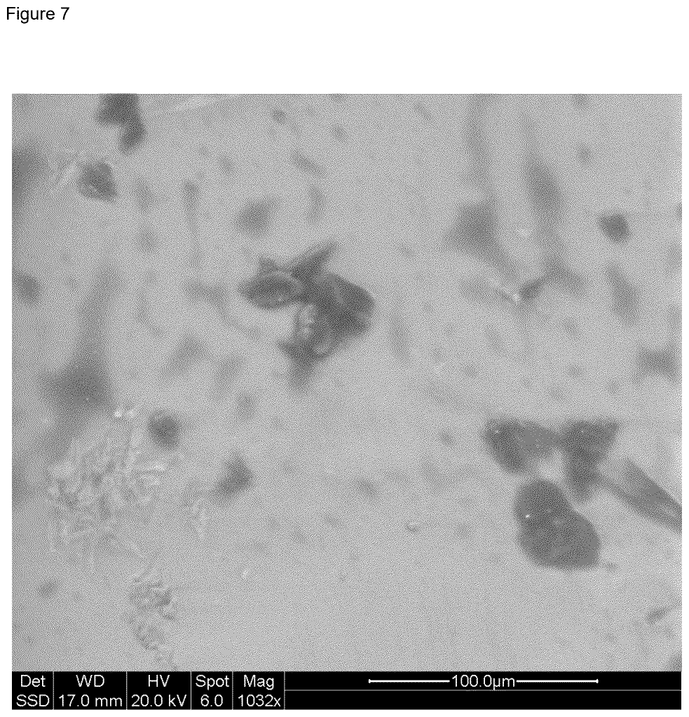

Talc (Mg₃Si₄O₁₀(OH)₂) and borax (Na₂B₄O₁₅(OH)₂) were mixed at 60 wt %/40 wt % concentrations and melted at 1275° C. FIG. 7 is an SEM image of the glass after holding at the melting temperature for about 36 hours. FIG. 7 shows darker gray areas within the glass matrix showing the presence of precipitated carbonates. This demonstrates that the glass formulations may even be used to react with CO₂ during the melting process.

Having illustrated and described the principles of the present invention, it should be apparent to persons skilled in the art that the invention can be modified in arrangement and detail without departing from such principles.

Although the materials and methods of this invention have been described in terms of various embodiments and illustrative examples, it will be apparent to those of skill in the art that variations can be applied to the materials and methods described herein without departing from the concept, spirit, and scope of the invention. All such similar substitutes and modifications apparent to those skilled in the art are deemed to be within the spirit, scope and concept of the invention as defined by the appended claims.

What is claimed is:

1. A method of preparing a carbon-negative glass, the method comprising:
(a) selecting an oxide glass having a composition characterized as comprising:
SiO₂ at an amount in a range of 0 mol % to about 60 mol %;
B₂O₃ at an amount in a range of 0 mol % to about 60 mol %;
MO at an amount in a range of about 20 mol % to about 50 mol %, wherein M is one or more alkaline earth elements;
R₂O at an amount in a range of about 5 mol % to about 50 mol %, wherein R is one or more alkaline elements;
P₂O₅ at an amount in a range of 0 mol % to about 60 mol %;
Al₂O₃ at an amount in a range of 0% to about 3 mol %; and
Fe₂O₃ at an amount in a range of 0% to about 15 mol %;
(b) selecting raw materials that comprise about 5 mol % or less of carbon at amounts suitable to form a batch that yields the oxide glass upon heating the batch to at least the melting temperature;
(c) heating the batch to at least the melting temperature to produce molten oxide glass; and
(d) decreasing the temperature of the molten oxide glass to produce solid oxide glass thereby forming the carbon-negative glass.

2. The method of claim 1, wherein M is selected from the group consisting of Ca, Mg, Ba, Sr, and combinations thereof and R is selected from the group consisting of Na, K, Li, and combinations thereof.

3. The method of claim 2, wherein the selected oxide glass composition is characterized as comprising:
SiO₂ at an amount in a range of about 30 mol % to about 50 mol %;
B₂O₃ at an amount in a range of about 15 mol % to about 30 mol %;
CaO at an amount in a range of 0 mol % to about 10 mol %;
MgO at an amount in a range of about 25 mol % to about 35 mol %;
Na₂O at an amount in a range of about 5 mol % to about 15 mol %; and
K₂O at an amount in a range of 0 mol % to about 5 mol %.

4. The method of claim 2, wherein the selected oxide glass composition is characterized as comprising:
SiO₂ at an amount in a range of about 30 mol % to about 45 mol %;
B₂O₃ at an amount in a range of 0 mol % to about 5 mol %;
CaO at an amount in a range of about 25 mol % to about 35 mol %;
MgO at an amount in a range of 0 mol % to about 5 mol %;
Na₂O at an amount in a range of about 5 mol % to about 15 mol %; and
K₂O at an amount in a range of 0 mol % to about 5 mol %.

5. The method of claim 2, wherein the selected oxide glass composition is characterized as comprising:
SiO₂ at an amount in a range of about 10 mol % to about 20 mol %;
B₂O₃ at an amount in a range of about 25 mol % to about 40 mol %;
CaO at an amount in a range of about 25 mol % to about 40 mol %;
MgO at an amount in a range of about 1 mol % to about 10 mol %; and
Na₂O at an amount in a range of about 10 mol % to about 20 mol %.

6. The method of claim 1, wherein the raw materials are selected from the group consisting of borax (Na₂B₄O₇•10H₂O), sodium silicate (Na₂SiO₃), sodium phosphate (Na₃PO₄), forsterite (Mg₂SiO₄), talc (Mg₃Si₄O₁₀(OH)₂), serpentite (Mg₆Si₄O₁₀(OH)₈), apatite, (Ca₅(PO₄)), diopside (MgCaSi₂O₆), boracite (Mg₃B₇O₁₃Cl), wollastonite (CaSiO₃), ultramafic basalts, fly ash, boiler ash, cement, soda lime glass, and combinations thereof.

7. The method of claim 1 further comprising forming the molten oxide glass so that the carbon-negative glass has a configuration selected from the group consisting of one or more fibers, one or more particles, carbon-capture filters, frit, tile, block, brick, and paver.

8. The method of claim 7, wherein the selected configuration is one or more fibers, wherein the formed fiber(s) of the carbon-negative glass have a cross-sectional distance perpendicular to an axis of fiber formation that is a range of about 1 μm to about 100 μm.

9. The method of claim 7, wherein the selected configuration is one or more particles, wherein the formed particle(s) of the carbon-negative glass have a largest cross-sectional distance that is in a range of about 1 μm to about 200 μm.

10. A glass product consisting of an oxide glass having a composition characterized as comprising:
SiO₂ at an amount in a range of 0 mol % to about 60 mol %;
B₂O₃ at an amount in a range of 0 mol % to about 60 mol %;
MO at an amount in a range of about 20 mol % to about 50 mol %, wherein M is one or more alkaline earth elements;
R₂O at an amount in a range of about 5 mol % to about 50 mol %, wherein R is one or more alkaline elements; and
P₂O₅ at an amount in a range of 0 mol % to about 60 mol %;
wherein the glass product has a configuration selected from the group consisting of fibers having a cross-sectional distance perpendicular to an axis of fiber formation that is no greater than about 100 μm, particles having a largest cross-sectional distance that is no greater than about 500 μm, frit, a tile, a brick, a block, and a paver.

11. A glass product consisting of the carbon-negative glass prepared according to the method of claim 1, wherein the glass product has a configuration selected from the group consisting of fibers having a cross-sectional distance perpendicular to an axis of fiber formation that is no greater than about 100 μm, particles having a largest cross-sectional distance that is no greater than about 500 μm, a carbon-capture filter, frit, a tile, a brick, a block, and a paver.

12. A ceramic product comprising a ceramic substrate and a fired glaze on at least a portion of the ceramic substrate, wherein a constituent of the glaze is the carbon-negative glass prepared according to the method of claim 1, and wherein the ceramic product has a configuration selected from the group consisting of tile, brick, and sanitary ware.

13. A sacrificial ceramic CO₂ sequestration architectural product, wherein the sacrificial ceramic CO₂ sequestration architectural product comprises a sintered/heat-treated mixture having an open porosity (determined by ASTM C830) that is in a range from about 15 vol % to about 50 vol %, wherein the sintered/heat-treated mixture comprises:
an amount of a glass product in a range of about 20 wt % to about 50 wt % of the sintered/heat-treated mixture, wherein the glass product has a configuration selected from the group consisting of fibers having a cross-sectional distance perpendicular to an axis of fiber formation that is no greater than about 100 μm, particles having a largest cross-sectional distance that is no greater than about 500 μm, and a combination thereof, and wherein the glass product consists of an oxide glass having a composition characterized as comprising:
SiO₂ at an amount in a range of 0 mol % to about 60 mol %;
B₂O₃ at an amount in a range of 0 mol % to about 60 mol %;
MO at an amount in a range of about 20 mol % to about 50 mol %, wherein M is one or more alkaline earth elements;
R₂O at an amount in a range of about 5 mol % to about 50 mol %, wherein R is one or more alkaline elements; and
P₂O₅ at an amount in a range of 0 mol % to about 60 mol %.

14. The sacrificial ceramic CO₂ sequestration architectural product of claim 13, wherein:
the melting temperature of the oxide glass is not less than about 1,100° C.;
the glass product is at amount in a range of about 30 wt % to about 40 wt % of the sintered/heat-treated mixture; and
the oxide glass of the sintered/heat-treated mixture is a carbon-negative glass.

15. The sacrificial ceramic CO₂ sequestration architectural product of claim 13, wherein the sintered/heat-treated mixture further comprises one or more non-reactive solid phases at an amount in a range from about 20 wt % to about 80 wt % of the sintered/heat-treated mixture, wherein each non-reactive solid phase comprises one or more weather-resistant materials selected from the group consisting of cement, one or more clays, one or more feldspars, quartz, non-reactive glasses, and combinations thereof; and
wherein:
the cement, if present, is at a total relative amount in a range of about 25 wt % to about 75 wt % of the sintered/heat-treated mixture;
the one or more clays, if present, are at total relative amount in a range of about 25 wt % to about 75 wt % of the sintered/heat-treated mixture;
the one or more feldspars, if present, are at total a relative amount in a range of about 10 wt % to about 40 wt % of the sintered/heat-treated mixture; and
the quartz, if present, is at a relative amount in a range of about 10 wt % to about 40 wt % of the sintered/heat-treated mixture.

16. The sacrificial ceramic CO₂ sequestration architectural product of claim 13 further comprising a fired glaze on at least a portion of at least one major surface of the sintered/heat-treated mixture, wherein a constituent of the glaze is a second oxide glass having a composition characterized as comprising:
SiO₂ at an amount in a range of 0 mol % to about 60 mol %;
B₂O₃ at an amount in a range of 0 mol % to about 60 mol %;
MO at an amount in a range of about 20 mol % to about 50 mol %, wherein M is one or more alkaline earth elements;
R₂O at an amount in a range of about 5 mol % to about 50 mol %, wherein R is one or more alkaline elements; and
P₂O₅ at an amount in a range of 0 mol % to about 60 mol %.

17. A process for making the sacrificial ceramic CO₂ sequestration architectural product that comprises a sintered/heat-treated mixture, the process comprising:
creating a mixture that comprises a glass product in a range of about 20 wt % to about 50 wt % of the mixture solids, wherein the glass product has a configuration selected from the group consisting of fibers having a cross-sectional distance perpendicular to an axis of fiber formation that is no greater than about 100 μm, particles having a largest cross-sectional distance that is no greater than about 500 μm, and a combination thereof, and wherein the glass product consists of an oxide glass having a composition characterized as comprising:
SiO₂ at an amount in a range of 0 mol % to about 60 mol %;
B₂O₃ at an amount in a range of 0 mol % to about 60 mol %;
MO at an amount in a range of about 20 mol % to about 50 mol %, wherein M is one or more alkaline earth elements;
R₂O at an amount in a range of about 5 mol % to about 50 mol %, wherein R is one or more alkaline elements; and
P₂O₅ at an amount in a range of 0 mol % to about 60 mol %; forming the mixture; and
heating the formed mixture yield the sintered/heat-treated mixture, wherein the sintered/heat-treated mixture has an open porosity (determined by ASTM C830) that is in a range from about 15 vol % to about 30 vol %.

18. The process of claim 17, wherein:
the mixture further comprises one or more weather-resistant materials that are not susceptible to atmospheric carbon mineralization at a total relative amount in a range from about 20 wt % to about 80 wt % of the mixture, wherein the one or more weather-resistant materials are selected from the group consisting of one or more clays, one or more feldspars, quartz, non-reactive glasses, and combinations thereof; and
the formed mixture is heated to temperature(s) in a range from about 900° C. to about 1,100° C. for a duration in a range from about 4 hours to about 48 hours.

19. The process of claim 17 further comprising firing a glaze on at least a portion of at least one major surface of the sintered/heat-treated mixture, wherein a constituent of the glaze is a second oxide glass having a composition characterized as comprising:
SiO₂ at an amount in a range of 0 mol % to about 60 mol %;
B₂O₃ at an amount in a range of 0 mol % to about 60 mol %;
MO at an amount in a range of about 20 mol % to about 50 mol %, wherein M is one or more alkaline earth elements;
R₂O at an amount in a range of about 5 mol % to about 50 mol %, wherein R is one or more alkaline elements; and
P₂O₅ at an amount in a range of 0 mol % to about 60 mol %.

20. A process for sequestering atmospheric CO₂, the process comprising dispersing onto or within land a glass product having a configuration selected from the group consisting of fibers having a cross-sectional distance perpendicular to an axis of fiber formation that is no greater than about 100 μm, particles having a largest cross-sectional distance that is no greater than about 100 μm, and a combination thereof, and wherein the glass product consists of an oxide glass having a composition characterized as comprising:
SiO₂ at an amount in a range of 0 mol % to about 60 mol %;
B₂O₃ at an amount in a range of 0 mol % to about 60 mol %;
MO at an amount in a range of about 20 mol % to about 50 mol %, wherein M is one or more alkaline earth elements;
R₂O at an amount in a range of about 5 mol % to about 50 mol %, wherein R is one or more alkaline elements; and
P₂O₅ at an amount in a range of 0 mol % to about 60 mol %;
which exposes the dispersed glass product to CO₂ dissolved in water to form carbonic acid, which reacts with the alkaline earth elements and the alkaline elements in the oxide glass to produce carbonates, thereby sequestering atmospheric CO₂.
